(19) United States
(12) Patent Application Publication
(10) Pub. No.: US 2009/0048729 A1
(43) Pub. Date: Feb. 19, 2009

(54) METHOD FOR DIAGNOSING THE OPERATIONAL STATE OF A VARIABLE VALVE ACTUATION (VVA) DEVICE USING A KNOCK SIGNAL

(76) Inventors: James P. Waters, Waterford, MI (US); Jon C. Darrow, Brighton, MI (US); Timothy W. Kunz, Rochester, NY (US); Peter M. Olin, Ann Arbor, MI (US)

Correspondence Address: DELPHI TECHNOLOGIES, INC., M/C 480-410-202, PO BOX 5052, TROY, MI, 48007, US

(21) Appl. No.: 11/839,986

(22) Filed: Aug. 16, 2007

(51) Int. Cl. G01M 15/04

(52) U.S. Cl. 701/29

(57) ABSTRACT

A method for determining whether a variable valve actuation (VVA) device or subsystem is operating in an improper mode of operation is performed in real-time by an embedded engine or powertrain controller configured to monitor and evaluate an already-available knock sensor output signal. The knock sensor output is captured during a predefined sampling window, defined to include a valve closing event when the VVA device is operating in a proper mode. The captured knock sensor output signal is processed to detect the presence (or absence) of a valve closing event. The absence of a valve closing event when one is expected is indicative of a malfunctioning VVA device.

### TECHNICAL FIELD

The present invention relates to a method for diagnosing the operational state of a variable valve actuation (VVA) device using a knock signal.

### BACKGROUND OF THE INVENTION

Historically, the performance of an internal combustion engine has been limited by fixed valve lift profiles, i.e., fixed timing of the opening and closing of the valves relative to the angular position of the engine crankshaft and fixed lift of the valves. However, modern internal combustion engines may utilize one of several methods and/or devices to vary the valve lift profile to, at least in part, control the flow of gas and/or air into and/or out of the engine cylinders. Modern internal combustion engines may utilize devices, such as, for example, variable valve actuating mechanisms, two-step cam profile switching mechanisms (i.e., variable valve lift devices (VVL)), and deactivation valve lifters to vary the amount by which the valves of an engine are lifted (i.e., opened). Furthermore, engines may utilize devices, such as variable valve actuating (VVA) mechanisms and cam phasers, to vary the timing of the opening and/or closing of the engine valves relative to the angular position of the engine crankshaft. These VVA devices each have multiple modes of operation. For example, a variable valve lift (VVL) device has a “low lift” mode of operation and a “high lift” mode of operation. As a further example, a cylinder deactivation device has a “deactivation on” mode and a “deactivation off” mode. The selected mode of operation therefore alters the operation of the engine.

The addition of such variable valve actuation (VVA) hardware subsystems to internal combustion engines (e.g., both spark ignited and compression ignited) as described above introduces the challenge of detecting proper function as well as diagnosing improper function of one or more elements of the VVA subsystem (e.g., is the VVA device operating in the proper mode of operation?). There are differing diagnostic requirements of rigor based on whether the failure mode and its associated strategy is for OBD II compliance, Comprehensive Components compliance, or for device protection. Moreover, there are hardware consequences to the product designer for an inability to diagnose improper function during operation. For example, for a 2-step VVL device, the inability to diagnose “failure to achieve high lift” would require that the low-lift cam profile be robust to high engine speeds (e.g., redline), and this may force compromises in the design that can erode fuel economy benefits of low-lift operation. Type 2 cylinder deactivation hardware faces similar design issues.

Conventional diagnostic approaches taken to date have their practical limitations. As the primary function of VVA subsystems is to modify the pumping characteristics of the engine, and thus its combustion and torque characteristics, early implementations of VVA diagnostic algorithm strategies focused on using the existing engine sensors that monitor engine pumping and combustion parameters. However, as DOHC style engines—engines with more than 2 valves/cylinder—have become more common, it has been observed that this configuration has had the effect of reducing the signal-to-noise (S/N) ratio of such diagnostics.

For example, U.S. Pat. No. 7,047,924 entitled “METHOD FOR DIAGNOSING THE OPERATIONAL STATE OF A TWO-STEP VARIABLE VALVE LIFT DEVICE” issued to Waters et al., owned by the common assignee of the present invention and incorporated in its entirety herein, disclose a diagnostic method involving a comparison of estimated and expected engine cylinder pressures (e.g., a combustion parameter). The concept being that there may be a factor of 1.5 to 2 of separation between the cylinder pressures for the two modes of operation of the cylinders of an engine including a two-step variable valve lift device.

Finally, market pressure to minimize vehicle-level on-cost of these VVA technologies makes it desirable for any candidate diagnostic strategy to make use of the existing functionality wherever possible.

There is therefore a need for a low or no additional cost method for diagnosing a variable valve actuation (VVA) device or subsystem in an automotive vehicle.

### SUMMARY OF THE INVENTION

The present invention is directed to a method for determining whether a variable valve actuation (VVA) device or subsystem is operating in an improper mode of operation. The method may performed in real-time by an embedded engine or powertrain controller configured to monitor and evaluate an already-available knock sensor (or sensors) output signal(s) obtained during a predetermined sampling window. The knock sensor signal can be processed to detect the presence (or absence) of an engine valve closing event. When a valve closing event is detected during the sampling window (i.e., the window being set-up in advance so as to include the expected valve closing event when the VVA device is operating properly), then the method can confirm proper function (i.e., no malfunction). Conversely, failure to detect valve closing events when they are expected to occur is indicative of a VVA malfunction.

A method according to the invention is therefore provided for diagnosing a variable valve actuation (VVA) device (or subsystem) associated with at least one valve in an engine. The VVA device is capable of operating in a plurality of operational modes. In one embodiment, the VVA device is a cylinder deactivation device (e.g., valve lifters). In another embodiment, the VVA device is a variable valve lift device (e.g., 2-step VVL device). In a still further embodiment, the VVA device may be a camshaft phasing device configured to adjust the phasing of a camshaft relative to a crankshaft angular position. The method includes several steps.

The first step involves defining a sampling window as a function of a selected operational mode of the VVA device. The VVA device being diagnosed will have an expected status during the defined-in-advance sampling window, corresponding to either the presence or the absence of a valve (or valves) closing event(s). The particulars of the sampling window (e.g., start time, duration, etc.) may be defined in either the time domain or the crankshaft angle domain. The next step of the method involves determining an actual status of the VVA device based on a knock sensor signal (or alternatively signals) obtained during the sampling window. The actual status corresponds to the presence or absence of a valve (or valves) closing event(s). The final step of the method involves recording a VVA device fault indicating that the VVA device is operating in an improper operating mode when the actual status (determined from the knock sensor signal) differs from the expected status.

The present invention, by utilizing a precisely determined sampling window (or multiple windows) is capable of sharing (e.g., with a spark knock control system) the output signal from an existing spark knock sensor with no additional cost beyond electronic controller resources (e.g., RAM, ROM and throughput).

While the present invention will find particular advantage as a diagnostic process embedded in an on-board controller of an automotive vehicle, it is also contemplated that the present invention may be alternatively embodied in automotive service and repair devices, for example, such as those that may be available for use by technicians in a dealer service bay (e.g., Tech-2 type devices).

Other features and advantages of the present invention are also presented.

### BRIEF DESCRIPTION OF THE DRAWINGS

The present invention will now be described, by way of example, with reference to the accompanying drawings.

FIG. 1 is a schematic diagram of a system that may be used to implement the method of the present invention, showing an engine control module and an internal combustion engine including a variable valve actuation (VVA) device or subsystem.

FIG. 2 is a timing diagram showing a pair of knock sensor output signals illustrating the presence of a valve closing event during a sampling window.

FIG. 3 is a timing diagram showing a pair of knock sensor output signals illustrating the absence of a valve closing event during a sampling window.

FIG. 4 is a flowchart diagram showing the diagnostic method of the present invention.

FIG. 5 is a flowchart diagram showing, in greater detail, a VVA diagnostic feature of the method of FIG. 4.

FIG. 6 is a simplified flowchart diagram showing, in greater detail, a healthy engine diagnostic feature of the method of FIG. 4.

### DETAILED DESCRIPTION OF THE PREFERRED EMBODIMENT

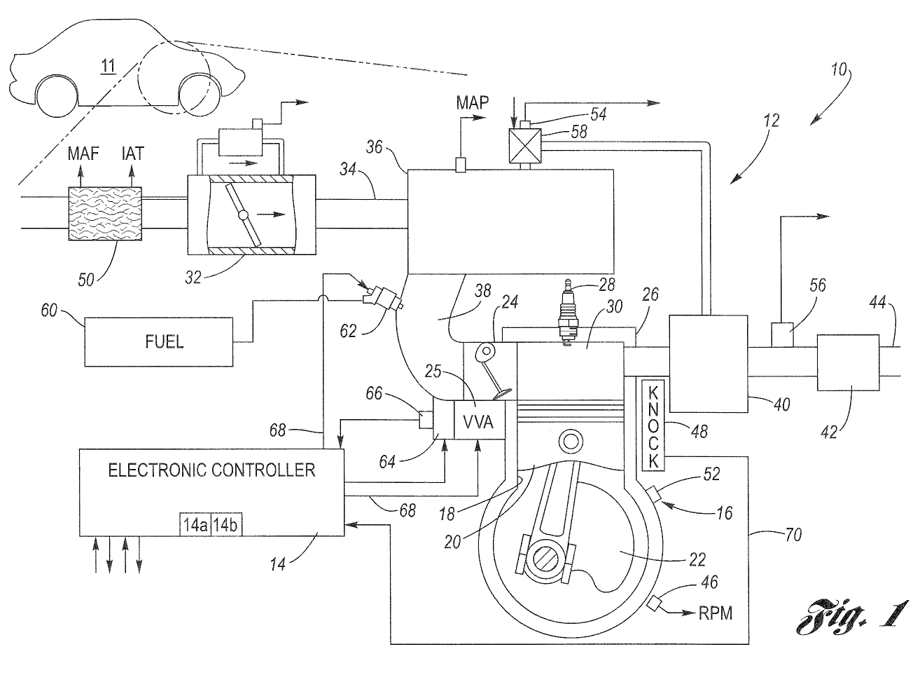

Referring now to the drawings, wherein the Figures are for the purpose of illustrating an embodiment of the invention only, FIG. 1 shows an internal combustion engine system 10 in an automotive vehicle 11. The system 10 includes an internal combustion engine 12 controlled by an electronic engine controller 14, all in accordance with the present invention.

Engine 12 may be a spark-ignition engine that includes a number of base engine components, sensing devices, output systems and devices, and a control system. And while the description of the present invention will take the form of a diagnostic method embedded in controller 14 of vehicle 11, it should be understood that other embodiments, such as, for example, stand-alone devices of the type used in a dealer service center, may be alternatively configured in accordance with the present invention as well.

With continued reference to FIG. 1, electronic controller 14 is configured via suitable programming to contain various software algorithms and calibrations, electrically connected and responsive to a plurality of engine and vehicle sensors, and operably connected to a plurality of output devices. Controller 14 includes at least one microprocessor, associated memory devices such as read only memory (ROM) 14a and random access memory (RAM) 14b, input devices for monitoring input from external analog and digital devices, and output drivers for controlling output devices. In general, controller 14 is operable to monitor engine operating conditions and operator inputs using the plurality of sensors, and control engine operations with the plurality of output systems and actuators, using pre-established algorithms and calibrations that integrate information from monitored conditions and inputs. The software algorithms and calibrations which are executed in electronic controller 14 may generally comprise conventional strategies known to those of ordinary skill in the art. These programmed algorithms and calibrations are configured, when executed, to monitor the engine operating conditions and operator demands using the plurality of sensors, and control the plurality of engine actuators accordingly. The software algorithms and calibrations are preferably embodied in pre-programmed data stored for use by controller 14.

While a more detailed description of the various components shown in FIG. 1 will be set forth below, for purposes of the present invention, the most immediately applicable aspects of system 10 will be described first. In this regard, engine 12 may include, among other things, one or more air intake valves 24 and associated lift mechanization, as well as a variable valve actuation (VVA) device 25 operably coupled thereto. In one embodiment, engine 12 may be a multi-valve (e.g., DOHC) configuration. The VVA device 25 may take a number of different forms. For example, VVA device 25 may take the form of a valve lift actuation device for implementing a cylinder deactivation feature, as known generally in the art. VVA device 25 may alternatively take the form a variable valve lift actuation device (e.g., a 2-step variable valve lift device), as also known generally in the art. VVA device 25 may still further take the form of a camshaft phasing device configured to phase (adjust) the camshaft (and hence the timing) with respect to the engine crankshaft position, also as known generally in the art.

VVA device 25 is controlled in accordance with a control signal 68 generated by electronic controller 14 pursuant to various pre-programmed strategies consistent with the type of VVA embodiment, as known. Additionally, each embodiment of VVA device 25 may be described as operating in one of a plurality of different operating modes. For example, for a cylinder deactivation valve lifter device, a first mode may be a “cylinder deactivation on” mode, while a second, different mode may be a “cylinder deactivation off” mode. Likewise, for a two-step variable valve lift (VVL) embodiment, a first mode of operation may be a “low lift” mode and a second, different mode of operation may be a “high lift” mode. For a cam phaser embodiment, various modes of operation correspond to the various, corresponding camshaft adjustments which result in differing valve opening/closing times with respect to the crankshaft angular position. One of ordinary skill in the art will recognize these and the many other variations that are possible.

FIG. 1 further shows a spark knock detection sensor 48 configured to generate a corresponding knock sensor output signal 70. As known to one of ordinary skill in the art, engine 12 may already be pre-configured to include one or more knock sensors 48 as part of its spark ignition control system. As known, in general, controller 14 is configured to evaluate input from such sensors 48 and make adjustments, if necessary, to its control strategy to minimize or eliminate the occurrence of knock. Knock sensor(s) 48 may comprise conventional components known to those in the art.

Diagnostics are desired and/or required to have varying levels of detection and reporting capability with respect to any variable valve actuation (VVA) device included in vehicle 11. For example only, the so-called on board diagnostics II (OBD-II) regulations, “Comprehensive Components” requirements, and the like specify particular diagnostic capabilities to ensure that key operating features and components of the vehicle are not malfunctioning.

A first aspect of the present invention therefore involves determining proper VVA function, and is based on detecting the sound of the valve closing events of the VVA valve-lines of interest using one or more knock sensors 48. By utilizing a precise sampling window, either in the time domain or the crank angle domain, it is possible for both the spark knock control system and a VVA diagnostic system to share the output signal of the existing knock sensor or sensors, with no additional on-cost beyond processor resources (RAM, ROM and throughput).

A second aspect of the present invention involves verifying that the engine (and its rotating and/or reciprocating subsystems) is otherwise (i.e., other than its VVA device(s)) healthy before relying on the knock signal-based diagnostic to determine proper VVA device or subsystem function. As described above, a sampling window(s), either in the time domain or the crank angle domain, may be established for testing for the presence or absence of valve closing events. In this second aspect, an additional sampling window or multiplicity of sampling windows may be established for specifically targeting a quiet zone of “no expected valve closing events”. The electronic controller 14 is configured to monitor the valve-lines for proper operation, as a rationality check. This is to prevent the diagnostic algorithm for detecting VVA malfunction from falsely identifying a catastrophic failure elsewhere in the valve-line as a VVA device malfunction.

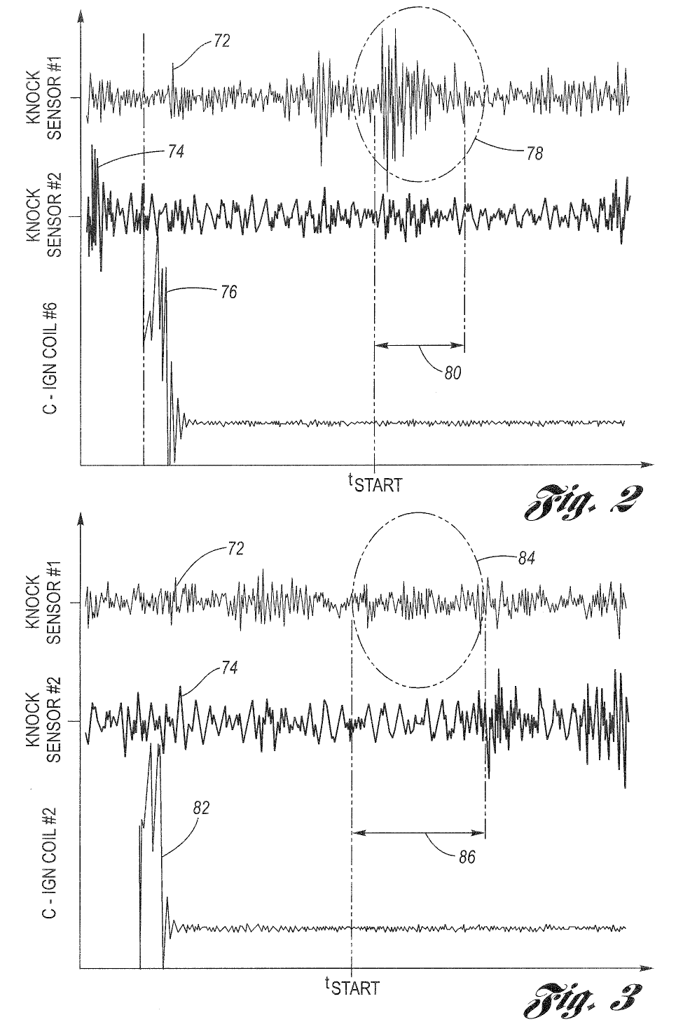

FIG. 2 is a timing diagram showing the outputs from a pair of knock sensors 48, whose outputs are designated by traces 72, 74, installed in engine 12, along with an ignition coil output reference (trace 76) as understood by one of ordinary skill in the art. The example is for a valve lift device for implementing a cylinder deactivation feature, and is shown for the mode of operation where the cylinder deactivation is “off” (i.e., all cylinders are active). Further, the engine is running at a speed of approximately 1600 RPM, with an indicated mean effective pressure of 450. As shown in the encircled region 78, trace 72 associated with the first knock sensor exhibits a higher level output indicative of a valve closing event. This is because the knock sensor picks up the disturbances caused by the valve seating. Note, that the knock sensor output signal, while relatively noisy, is more than adequate to determine the presence or absence of a valve closing event itself. For frame of reference, a sampling window 80 may be defined as a function of the selected mode of operation (i.e., “deactivation off”), i.e., defined so as to include an expected valve closing event or events. In this regard, the sampling window may be further defined in terms of both a starting time (i.e., a time designated tstart, or a corresponding crankshaft angle) and a duration (as shown). The controller 14 is configured to evaluate the knock output signal obtained during the sampling window, and here to determine the presence of a valve closing event.

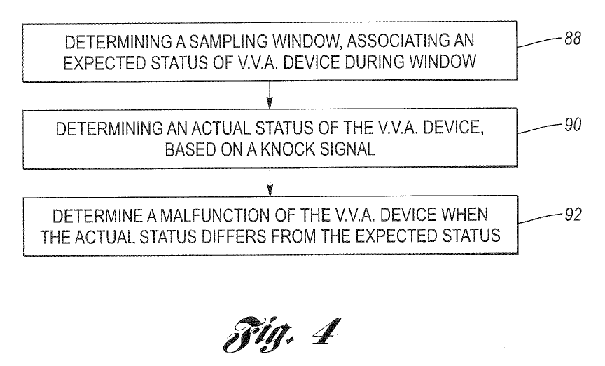

FIG. 3 is also a timing diagram showing the outputs from the same pair of knock sensors 48, those outputs are designated by traces 72, 74, installed in engine 12, along with an ignition coil output reference (trace 82) as understood by one of ordinary skill in the art. The example in FIG. 3 is also for the same device for implementing a cylinder deactivation feature, and is shown for the mode of operation where the cylinder deactivation is “on” (i.e., cylinders 1-3-5 are inactive). Further, the engine is running at a speed of approximately 1600 RPM, with an indicated mean effective pressure of 450. As shown in the encircled region 84, trace 72 associated with the first knock sensor exhibits no appreciable heightened increase in its output that would indicate a valve closing event. Sampling window 86 may be defined as a function of the selected mode of operation (i.e., “deactivation on”), i.e., defined so as to enclose, as expected, the absence of any valve closing event or events. Again, the sampling window may be further defined in terms of both a starting time (i.e., a time designated tstart, or a corresponding crankshaft angle) and a duration (as shown). The controller 14 is configured to evaluate the knock output signal obtained during the sampling window, and here to determine the absence of a valve closing event.

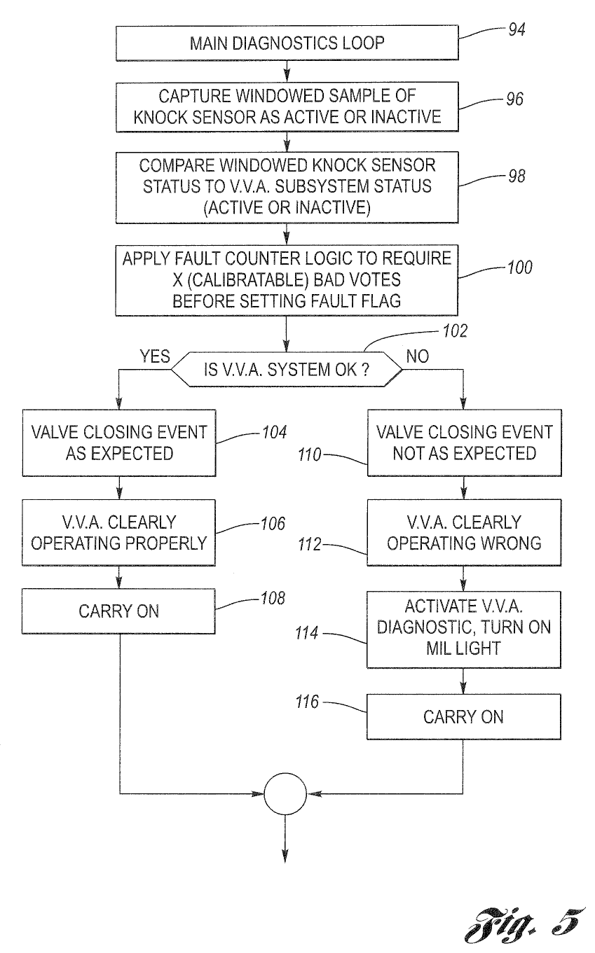

FIG. 4 is a flowchart diagram illustrating the basic method of the present invention. The method for diagnosing a variable valve actuation (VVA) device associated with at least one valve in the engine, where the VVA device is capable of operating in a plurality of operational modes, begins in step 88.

Step 88 involves defining a sampling window as a function of a selected operational mode. The VVA device or subsystem being diagnosed will have an expected status during the sampling window corresponding to either the presence or absence of a valve (or valves) closing event(s). That is, in a preferred embodiment, the sampling window is defined/selected (specifically with respect to timing and duration) so as to include the expected valve closing event. Note, as the mode of operation changes, so too will the particulars of the sampling window. The particulars of the sampling window (e.g., start time, duration, etc.) may be defined in either the time domain or the crankshaft angle domain. The method then proceeds to step 90.

Step 90 involves determining an actual status of the VVA device based on a knock sensor output signal (or alternatively multiple knock sensor output signals) obtained during the sampling window or windows. The actual status of the VVA device or subsystem (e.g., “active” or “inactive”) corresponds to the presence or absence of a valve (or valves) closing event(s). The method then proceeds to step 92.

Step 92 involves recording a VVA device or subsystem fault, indicating that the VVA device or subsystem is operating in an improper operating mode, when the actual status (i.e., determined from the knock sensor output signal) differs from the expected status.

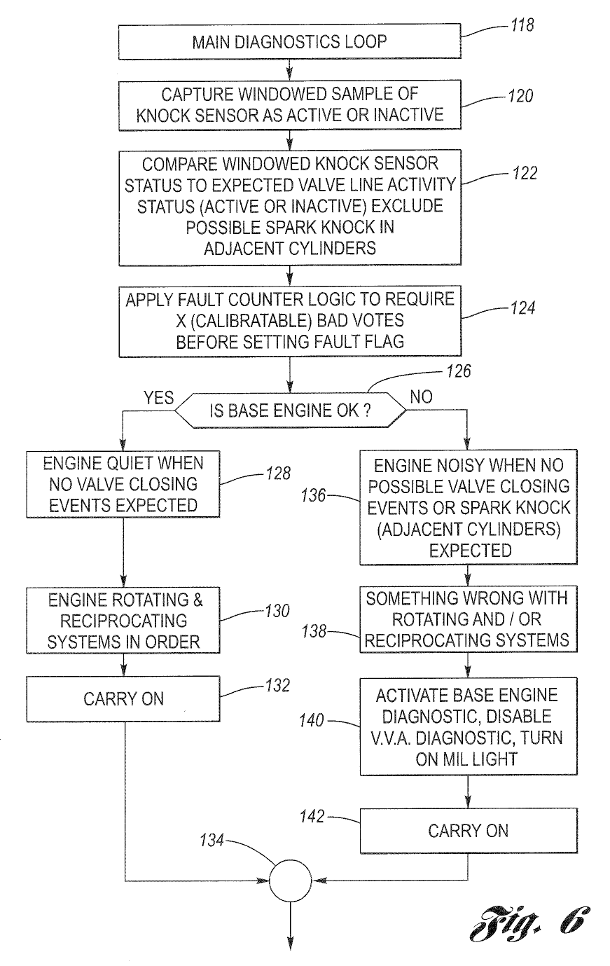

FIG. 5 shows, in greater detail, a flowchart for the logic of FIG. 4 as applied to a VVA device/subsystem. The method begins in step 94 (“main diagnostic loop”) and then proceeds to step 96.

In step 96, the method captures the knock sensor output signal obtained during the sampling window. The controller 14, in the method, is configured to determine whether the observed knock sensor output is indicative of the presence of a valve closing event (“ACTIVE”) or indicative of the absence of any valve closing events (“INACTIVE”). The method then proceeds to step 98.

In step 98, the method compares the windowed knock sensor status determined in step 96 to the VVA device or subsystem status (“ACTIVE” or “INACTIVE”), for example as maintained by controller 14. If the comparison indicates a match, then the knock sensor output in effect confirms that the VVA device/subsystem is operating in the proper mode of operation. However, if the comparison indicates a mismatch, then a counter is incremented. The method then proceeds to step 100.

In step 100, the method is configured to apply predetermined fault counter logic. The purpose of this logic is to ensure that noise or other transient influences do not falsely cause a fault flag to be set by the method. In the illustrated embodiment, a predetermined number (“X”) of counter increments (“bad votes”) must be incurred before the method will set a VVA fault flag. The method then proceeds to step 102.

In step 102, the method determines whether the VVA fault flag has been set. If the fault flag has not been set, then the VVA device/subsystem is operating properly, in the expected mode of operation. In this case, the method proceeds to steps 104 and 106, which confirm that the valve closing event(s) were as expected for the particular operating mode and that the VVA device/subsystem is clearly operating properly. The main diagnostic loop then proceeds through step 108, where mainline execution by controller 14 is resumed.

However, if the VVA fault flag has been set, then the answer in step 102 is that the VVA device/subsystem is not operating properly (i.e., not in the proper mode of operation, or otherwise malfunctioning). The method proceeds to steps 110 and 112, which confirm that any valve closing events were not as expected, and that the VVA device/subsystem is clearly operating improperly. The method proceeds to step 114.

In step 114, the method is further configured to activate a VVA diagnostic (e.g., an alert or the like), and, in one embodiment, command that a malfunction indicator lamp (MIL) be illuminated (observable to an operator or technician, for example, as known). The main diagnostic loop then proceeds through step 116, where mainline execution by controller 14 is resumed.

FIG. 6 shows, in greater detail, a flowchart for the logic of FIG. 4 as applied to a “healthy engine check.” This aspect of the invention calls for an additional sampling window or multiplicity of sampling windows, specifically targeting a quiet zone of “no expected valve closing events” for monitoring the valve-lines for proper operation, as a rationality check. This check is to prevent the VVA diagnostic method from falsely identifying a catastrophic failure elsewhere in the valve-line as a VVA malfunction. In effect, this additional aspect involves diagnosing the functioning of at least the rotating and/or reciprocating subsystems of the engine and setting an unhealthy engine fault when one of these subsystems is malfunctioning. The method begins in step 118, and then proceeds to step 120.

In step 120, the method defines one or more verification windows as a function of at least the available operating modes of the VVA device/subsystem so as to ensure that no valve closing events occur during the verification window (“quiet zone”). Then, the knock sensor output captured during the verification window is evaluated by controller 14 to determine the actual status, i.e., the presence (“ACTIVE” status) or absence (“INACTIVE” status) of valve closing events. The method proceeds to step 122.

In step 122, controller 14 compares the actual status determined in step 120 with an expected valve (or valve-line) activity status, which is either “ACTIVE” or “INACTIVE”. As above with the VVA device diagnostic method, when the comparison yields a match, activity is as expected and no malfunction is present. However, when the actual status does not match the expected status, then a base unhealthy engine fault counter is incremented. While the windowing function will inherently exclude episodes of actual spark knock for the subject cylinder since combustion does not occur at or around valve closing, an additional safeguard is warranted. Specifically, active spark knock occurring in adjacent cylinders, for some engine configurations, may occur at the same time as a valve closing event in the subject cylinder. Therefore, the present invention provides for an additional check and will exclude activity that could possibly be active spark knock occurring in an adjacent cylinder. The method proceeds to step 124.

In step 124, the method applies predetermined fault counter logic. The purpose of this logic is to ensure that noise or other transient influences do not falsely cause a base unhealthy engine fault flag to be set. In the illustrated embodiment, a predetermined number (“X”) of base unhealthy engine fault counter increments (“bad votes”) must be incurred before the method will set an unhealthy engine fault flag. The method then proceeds to step 126.

In step 126, the method determines whether the unhealthy engine fault flag has been set. If the unhealthy engine fault flag has not been set, then the base engine (apart from whether or not the VVA device/subsystem is operating properly) is in fact operating properly. In this case, the method proceeds to steps 128 and 130, which confirm that the engine was “quiet” when no valve closing event(s) were expected, and that the engine rotating and reciprocating subsystems are operating properly. The main diagnostic loop then proceeds through steps 132/134 where mainline execution by controller 14 is resumed.

However, if the unhealthy engine fault flag has been set, then the answer in step 126 is that the base engine (apart from VVA device/subsystem) is not operating properly. The method proceeds to steps 136 and 138, which confirm that the engine was “noisy” when no possible valve closing events (or when no possible active spark knock from adjacent cylinders) were expected, and that either the rotating and/or reciprocating subsystems of the engine are malfunctioning in some regard. The method proceeds to step 140.

In step 140, the method is further configured to activate a base engine diagnostic (e.g., alert or the like), disable the VVA device/subsystem diagnostic method (i.e., as set forth in steps 94-116), and, in one embodiment, command that a malfunction indicator lamp (MIL) be illuminated. The main diagnostic loop then proceeds through steps 142, 134 where mainline execution by controller 14 is resumed.

The present invention uses precise windowing of an already-available knock signal to diagnose the proper function of a VVA device or subsystem. This diagnostic capability can be added without any additional cost other than for processor resources (RAM, ROM and throughput).

With reference now again to FIG. 1, further details concerning system 10 will be set forth to more fully describe the exemplary environment for the present invention. It should be understood that portions of the following are exemplary only and not limiting in nature. Many other configurations are known to those of ordinary skill in the art and are consistent with the teachings of the present invention.

The base engine components of engine 12 include an engine block 16 with a plurality of cylinders, one of which is shown in FIG. 1 and is designated cylinder 18. Each cylinder 18 contains a respective piston 20 operably attached to a crankshaft 22 at a point eccentric to an axis of rotation of crankshaft 22. There is a head 26 at the top of each piston 20 containing one or more air intake valves 24 and associated lift mechanization, a variable valve actuation (VVA) device 25 operably coupled to valve 24, and one or more exhaust valves (not shown), and a spark plug 28. A combustion chamber 30 is formed within cylinder 18 between piston 20 and the head 26. An intake manifold is fluidly connected to engine head 26, substantially adjacent air intake valves 24. The intake manifold is connected to an air control valve 32, and includes a common air inlet 34 into a plenum 36, which flows into a plurality of parallel intake runners 38. The plurality of parallel intake runners 38 is preferably formed to permit flow of substantially equal volumes of air from the air control valve 32 to each of the plurality of cylinders 18. An exhaust manifold 40 is fluidly connected to engine head 26, substantially adjacent the exhaust valves, and facilitates flow of exhaust gases away from the engine to exhaust system components 42, 44.

The system 10 includes a variety of sensors. The plurality of sensing devices of the exemplary internal combustion engine 12 are operable to measure ambient conditions, various engine conditions and performance parameters, and operator inputs. Typical sensors include a crankshaft position sensor 46, a camshaft position sensor 66, a manifold absolute pressure (MAP) sensor, one or more spark knock sensors 48, a throttle position sensor (not shown), a mass air flow sensor 50, an intake air temperature (IAT) sensor (shown as an element of the mass air flow sensor 50), a coolant temperature sensor 52, an exhaust gas recirculation (EGR) position sensor 54, and one or more oxygen sensors or other exhaust gas sensors 56.

The plurality of output systems and devices of the exemplary internal combustion engine 12 are operable to control various elements of engine 12, and include an air intake system, a fuel injection system, an ignition system, an exhaust gas recirculation (EGR) valve 56 and related system, a purge control system (not shown) and exhaust system 42, 44. The air intake system is operable to deliver filtered air to the combustion chamber 30 when the intake valve(s) 24 are open. The air intake system preferably includes an air filtering system fluidly connected to air control valve 32, which is fluidly connected to the intake manifold.

FIG. 1 also shows a fuel source, designated by reference numeral 60, which feeds a set of fuel injectors 62 configured to deliver fuel to corresponding cylinders of engine 12, one of which is shown in FIG. 1. Fuel injector 62 may be placed in a corresponding intake runner 38 at an end of the runner adjacent to the engine head 26, substantially near the intake valve(s) 24 to the cylinder 18. Conventionally, fuel may be liquid fuel, but may alternatively comprise propane fuel, natural gas fuel (compressed natural gas-CNG), or other fuel types now known or hereafter developed. Design of an air intake system, including all of the aforementioned components, is known to one of ordinary skill in the art. The exemplary liquid fuel delivery and injection system comprises storage tank 60 mentioned above with a high-pressure fuel pump (not shown) that provides fuel to a fuel line and fuel rail (not shown) to deliver liquid fuel to each of the plurality of fuel injectors 62. Each fuel injector 62 is fluidly connected and operable to deliver a quantity of fuel to one of the plurality of intake runners 38. Each fuel injector 62 is controlled according to a respective fuel injection signal generated by the electronic controller 14 and delivered via a respective electrical connection. Each fuel injection signal controls the open time of the associated fuel injector. Mechanization of an internal combustion engine, using sensors, output devices, and controller 14 including development of algorithms and calibrations, is known to those of ordinary skill in the art.

FIG. 1 further shows an intake cam phaser 64 and associated camshaft position sensor 66. Intake cam phaser 64 may be a conventional cam phaser as described in commonly-assigned U.S. Pat. No. 6,883,478 to Borraccia et al., entitled Fast-Acting Lock Pin Assembly for a Vane-Type Cam Phaser, which was filed on May 16, 2003, the disclosure of which is incorporated herein by reference. Intake cam phaser 64 enables phasing of the intake cam relative to engine crankshaft 22, i.e., the angular position of the camshaft relative to crankshaft 22 of engine 12. Intake cam phaser 64, if present, enables the opening and/or closing of the intake valves of engine 12 to be phased relative to the rotational or angular position of crankshaft 22, thereby phasing the opening and/or closing of the valves relative to piston position. Preferably, intake cam phaser 64 has a wide range of authority, i.e., is capable of phasing the intake cam over a wide range of angles relative to engine crankshaft 22, and is capable of substantially continuous phasing of the intake cam relative to engine crankshaft 22, rather than discrete phasing. Associated with intake cam phaser 64 is a phaser actuating device. Phaser actuating device may be for example a fluid control valve or electric motor associated with and configured to actuate cam phaser 64. Cam position sensor 66 may be for example a conventional electrical, optical or electromechanical cam position sensor and is associated with cam phaser 64. Cam position sensor 66 is electrically connected to a cam position input of controller 14.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A method for diagnosing a variable valve actuation (VVA) device associated with at least one valve in an engine, the VVA device being capable of operating in a plurality of operational modes, the method comprising:
defining a sampling window as a function of a selected operational mode, where the VVA device will have an expected status during the sampling window, corresponding to the presence or absence of a valve closing event;
determining an actual status of the VVA device based on a knock sensor output signal obtained during the sampling window where the actual status corresponds to the presence or absence of a valve closing event;
recording a VVA device fault indicating that the VVA device is operating in an improper operating mode when the actual status differs from the expected status.

2. The method of claim 1 wherein said step of defining a sampling window further includes the substeps of:
selecting a sampling domain from the group comprising a time domain and a crankshaft angular position domain; and
establishing a start time and a duration for the sampling window in the selected domain.

3. The method of claim 2 wherein the start time and duration are configured to include the valve closing event associated with the VVA device for the selected operational mode when the expected status is active.

4. The method of claim 2 wherein the start time and duration are configured to exclude any valve closing events for the selected operational mode when the expected status is inactive.

5. The method of claim 1 wherein the VVA device corresponds to a valve lift control device for implementing cylinder deactivation in the engine.

6. The method of claim 1 wherein the VVA device corresponds to a variable valve lift (VVL) device of the engine.

7. The method of claim 1 wherein the VVA device corresponds to a camshaft phasing device of the engine.

8. The method of claim 1 wherein the VVA device has associated therewith a plurality of valves defining a valvetrain.

9. The method of claim 1 further including the step of setting a fault flag associated with the VVA device after a predetermined number of recorded faults.

10. The method of claim 1 further including the step of:
diagnosing the functioning of at least one of a rotating and a reciprocating subsystem of the engine and setting an unhealthy engine fault when one of said subsystems is malfunctioning; and
invalidating any VVA device faults when the unhealthy engine fault has been set.

11. The method of claim 10 wherein said diagnosing step includes the substeps of:
defining a verification window as a function of at least the operating modes of the VVA device so as to ensure that no valve closing events occur during the verification window; and
evaluating a knock signal during the verification window and setting the unhealthy engine fault when valve closing event activity is detected.

12. The method of claim 1 further including the step of:
ignoring activity detected during the sampling window when operating data indicates possible combustion in an adjacent cylinder.
